(19) United States
(12) Patent Application Publication
(10) Pub. No.: US 2020/0278703 A1
(43) Pub. Date: Sep. 3, 2020

(54) Image Processing-Based Collision Avoidance System for Flight Vehicle and Flight Vehicle Including Same

(71) Applicant: Korea Advanced Institute of Science and Technology, Daejeon (KR)

(72) Inventors: Hyun Chul SHIM, Daejeon (KR); Jae Hyun Lee, Daejeon (KR); Han Seob Lee, Daejeon (KR)

(21) Appl. No.: 16/805,240

(22) Filed: Feb. 28, 2020

(30) Foreign Application Priority Data
Feb. 28, 2019 (KR) 10-2019-0023834
Feb. 28, 2019 (KR) 10-2019-0023835

(51) Int. Cl. G05D 1/10; G05D 1/00; G06T 7/269; G06T 7/73; G08G 5/00; G08G 5/04; G06N 20/00

(52) U.S. Cl. CPC G05D 1/1064; G05D 1/0094; G06T 7/269; G06T 7/74; G06T 2207/30252; G08G 5/045; G06N 20/00; G06T 2207/10016; G08G 5/0069

(57) ABSTRACT

The present invention relates to an image processing-based collision avoidance method and system for a flight vehicle, and a flight vehicle including the system. The present invention proposes a method in which an interest region containing a moving object is detected from a received image; and the interest region is enlarged to identify a type of the moving object, wherein when the moving object is detected, the received image is filtered and the moving object is detected on the basis of movement in the filtered image. Further, in the present invention, a forward image input unit obtaining a forward image of a direction in which the flight vehicle moves is provided on a vertical tail wing that is positioned on a first axis of the flight vehicle, the moving object is detected from the forward image for tracking, and then an avoidance path is generated.

### CROSS REFERENCE TO RELATED APPLICATIONS

The present application claims priority to Korean Patent Application No. 10-2019-0023834, filed Feb. 28, 2019 and Korean Patent Application No. 10-2019-0023835, filed Feb. 28, 2019, the entire contents of which are incorporated herein for all purposes by this reference.

### BACKGROUND OF THE INVENTION

### Field of the Invention

The present invention relates to a method of detecting and avoiding an intruder on the basis of an image to prevent collision of a flight vehicle, and a device in which the method operates.

### Description of the Related Art

In general, an unmanned aerial vehicle (UAV) refers to a flight vehicle that is operated by a pilot who controls the flight vehicle while not being on board. The unmanned aerial vehicle is firstly used for the case of conducting military actions which have a high probability of danger and loss of life, such as reconnaissance of enemy camps or attack on a target with missiles in combat situations, and in the present, the demand for the UAV in the private sector is rapidly increasing and a number of researches have been ongoing in recent years.

Recently, integrated operation of a UAV and a crewed aircraft has been prepared and studied. Herein, unlike a crewed aircraft, the UAV needs an aircraft detection technique to prepare for collision. While the UAV is in operation, the UAV may encounter an obstacle in the sky. The obstacles may be fixed or movable, and the locations thereof are not known in advance.

Using the conventional method of detecting and avoiding obstacles for the aircraft, the pilot of the unmanned aircraft may determine whether the aircraft is on the course of collision with obstacles. Also, the existing technology, which includes the Global Positioning System (GPS), for preventing collision with aircrafts, and obstacles has a limit in that many obstacles are not recognized (or not quickly recognized) via the GPS device, the existing technology is dependent on altitude or terrain, and the GPS accuracy performance varies greatly with environment.

In the related art, in order to solve this problem, radar has been used, but the system using radar is costly and is a high power system. Therefore, there is a limit in use in the private sector.

Accordingly, in recent years, an image processing technology has been developed, and an aircraft detection technique using an image has been at the fore. Herein, an image is received through a device equipped in the UAV, but it is impossible to stably receive an image of a forward area due to the movement of the UAV.

Also, the background of the received image changes with the movement of the UAV, and the obstacle is shown small in the received image. Thus, there is a problem with tracking the obstacle or determining whether the obstacle is an intruder.

Therefore, there is a need for a technique for stably receiving an image and processing the received image.

The foregoing is intended merely to aid in the understanding of the background of the present invention, and is not intended to mean that the present invention falls within the purview of the related art that is already known to those skilled in the art.

### SUMMARY OF THE INVENTION

The present invention is intended not to be influenced by deformation of a wing according to flight of a flight vehicle, and is intended to receive an image to avoid vibration.

The present invention is intended to add, to a flight vehicle, an image input device according to the International Civil Aviation Organization (ICAO) standard.

The present invention is intended to provide hardware and an algorithm for an image-based detect-and-avoid (DAA) technique.

The present invention is intended to provide a device and a method for safely avoiding both a cooperative aircraft and a non-cooperative aircraft.

The present invention is intended to use a sensor to stably detect and track an obstacle that is present in a flight path.

The present invention is intended to provide an image processing method for detecting and tracking an obstacle that is present in a flight path.

It is to be understood that technical problems to be solved by the present invention are not limited to the aforementioned technical problems and other technical problems which are not mentioned will be apparent from the following description to a person with ordinary skill in the art to which the present invention pertains.

The present invention relates to an image-based, specifically, image processing-based collision avoidance method and device for a flight vehicle. A detect-and-avoid (DAA) method for collision avoidance for a flight vehicle includes: receiving an image from an input unit provided on the flight vehicle; detecting an interest region containing a moving object from the received image; enlarging the interest region to identify a type of the moving object; and avoiding the moving object when the moving object is in a path of the flight vehicle. Herein, when the moving object is detected, the received image is filtered and the moving object is detected on the basis of movement in the filtered image.

According to an embodiment of the present invention, when the received image is filtered, the received image is binarized to generate a binarization image, and then a first image and a second image are generated with respect to the binarization image, and a difference image between the first image and the second image is obtained. Herein, a first image and a second image may be images obtained by applying different morphology operations.

According to an embodiment of the present invention, among one or more objects contained in the filtered image, an object of which at least one among a movement direction and a movement speed is different from that of the other objects may be determined as the moving object.

The present invention relates to an image-based detect-and-avoid (DAA) system for a flight vehicle. The detect-and-avoid (DAA) system includes: a forward image input unit obtaining an forward image of a direction in which the flight vehicle moves; a moving-object tracking unit detecting and tracking a moving object in the forward image; an information collection unit managing and collecting information for generating an avoidance path, which includes information on the detected moving object; an avoidance path generation unit generating the avoidance path on the basis of the information for generating the avoidance path; and an output unit outputting the information on the detected moving object and the avoidance path.

According to an embodiment of the present invention, the forward image input unit may be provided on a top of a vertical tail wing that is positioned on a first axis of the flight vehicle. Also, the forward image input unit may be composed of three electro-optic (EO) sensors. More specifically, the forward image input unit may be composed of a first sensor that is positioned to be parallel to the first axis of the flight vehicle, of a second sensor that is positioned on a right at an angle of 70 degrees with respect to the first sensor and the first axis of the flight vehicle, and of a third sensor that is positioned on a left at an angle of 70 degrees with respect to the first sensor and the first axis of the flight vehicle.

According to an embodiment of the present invention, the system may further include an assist flight vehicle information input unit, wherein the assist flight vehicle information input unit may transmit information on an assist flight vehicle, which is received from an automatic dependent surveillance-broadcast (ADS-B) reception sensor, to the moving-object tracking unit.

According to an embodiment of the present invention, the information collection unit may collect information on the flight vehicle and the information on the assist flight vehicle, which are received, and may provide the collected information to the avoidance path generation unit for generating the avoidance path.

According to an embodiment of the present invention, the moving-object tracking unit may detect an interest region containing the moving object from the forward image and may enlarge the interest region to identify a type of the moving object.

According to an embodiment of the present invention, the moving-object tracking unit may receive information on the interest region from the assist flight vehicle information input unit, and may detect the moving object on the basis of at least one piece of information among the information on the interest region and information on an analysis of the forward image.

According to an embodiment of the present invention, when the moving-object tracking unit detects the moving object, the forward image is filtered and the moving object is detected on the basis of movement in the filtered image.

According to an embodiment of the present invention, the moving-object tracking unit may enlarge the interest region and may perform deep learning to identify the type of the moving object.

According to an embodiment of the present invention, movement in the filtering image may be determined using an optical-flow technique.

According to the present invention, there is no influence of deformation of a wing according to the flight of the flight vehicle, and an image for avoiding vibration can be input.

According to the present invention, the image input device according to the ICAO standard can be added to the flight vehicle.

According to the present invention, hardware and an algorithm for an image-based detect-and-avoid (DAA) technique can be used.

According to the present invention, it is possible to use the device and the method for safely avoiding both a cooperative aircraft and a non-cooperative aircraft.

According to the present invention, it is possible to use the sensor to stably detect and track the obstacle that is present in the flight path.

According to the present invention, it is possible to use the image processing method for detecting and tracking the obstacle that is present in the flight path.

Effects that may be obtained from the present invention will not be limited to only the above described effects. In addition, other effects which are not described herein will become apparent to those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A and 1B are diagrams illustrating a configuration of a forward image input device in the related art and a forward image screen that is received;

FIG. 2 is a diagram illustrating a configuration of an image-based detect-and-avoid (DAA) system for a flight vehicle according to an embodiment of the present invention;

FIG. 3 is a diagram illustrating data that is transmitted and received in an image-based detect-and-avoid (DAA) system for a flight vehicle according to an embodiment of the present invention;

FIG. 4 is a diagram illustrating a structure of a forward image input unit that receives a forward image in an image-based detect-and-avoid (DAA) system for a flight vehicle according to an embodiment of the present invention;

FIGS. 5A to 5E are diagrams illustrating a structure of a forward image input unit that receives a forward image in an image-based detect-and-avoid (DAA) system for a flight vehicle according to an embodiment of the present invention;

FIG. 6 is a flowchart illustrating a detect-and-avoid (DAA) method of an image-based detect-and-avoid (DAA) system for a flight vehicle according to an embodiment of the present invention;

FIGS. 7A to 7C are diagrams illustrating operation of a detect-and-avoid (DAA) device for a flight vehicle according to an embodiment of the present invention;

FIG. 8 is a flowchart illustrating operation of a detect-and-avoid (DAA) device for a flight vehicle according to an embodiment of the present invention;

FIG. 9 is a diagram illustrating an image that is processed by a detect-and-avoid (DAA) method according to an embodiment of the present invention;

FIG. 10 is a diagram illustrating a general optical-flow operation;

FIGS. 11A to 11C are diagrams illustrating a result of simultaneously applying a close-minus-open (CMO) operation and an optical-flow operation as in the present invention; and

FIG. 12 is a diagram illustrating an output image screen according to an embodiment of the present invention.

### DETAILED DESCRIPTION OF THE INVENTION

Herein below, exemplary embodiments of the present invention will be described in detail with reference to the accompanying drawings such that the present invention can be easily embodied by those skilled in the art to which this present invention belongs. However, the present invention may be embodied in various different forms and should not be limited to the embodiments set forth herein.

In describing the embodiments of the present invention, if it is decided that the detailed description of known function or configuration related to the invention make the subject matter of the invention unclear, the detailed description is omitted. Also, parts that are not related to the description of the present invention are omitted from the drawings, and like reference numerals designate like parts.

In the present invention, when a constituent element is “coupled to”, “combined with”, or “connected to” another constituent element, it can be directly coupled to the other constituent element or intervening constituent elements may be present there between. Also, when a component “comprises” or “includes” a constituent element, unless there is another opposite description thereto, the component does not exclude other constituent elements but may further include the constituent elements.

In the present invention, the terms “first”, “second”, etc. are only used to distinguish one constituent element from another constituent element. Unless specifically stated otherwise, the terms do not denote an order or importance. Thus, without departing from the scope of the present invention, a first constituent element of an embodiment could be termed a second constituent element of another embodiment. Similarly, a second constituent element of an embodiment could also be termed a first constituent element of another embodiment.

In the present invention, constituent elements that are distinguished from each other to clearly describe each feature do not necessarily denote that the constituent elements are separated. That is, a plurality of constituent elements may be integrated into one hardware or software unit, or one constituent element may be distributed into a plurality of hardware or software units. Accordingly, even if not mentioned, the integrated or distributed embodiments are included in the scope of the present invention.

In the present invention, constituent elements described in various embodiments do not denote essential constituent elements, and some of the constituent elements may be optional. Accordingly, an embodiment that includes a subset of constituent elements described in another embodiment is included in the scope of the present invention. Also, an embodiment that includes the constituent elements which are described in the various embodiments and additional other constituent elements is also included in the scope of the present invention.

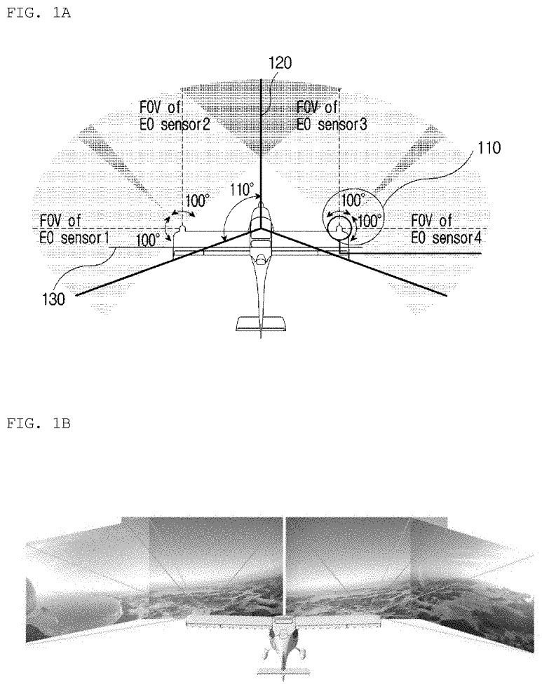

Hereinafter, a device and a method according to an embodiment of the present invention will be described with reference to the accompanying drawings. The part necessary to understand the operation and the effect according to the present invention will be particularly described in detail. FIGS. 1A and 1B are diagrams illustrating a configuration of a forward image input device in the related art and a forward image screen that is received.

More specifically, FIG. 1A is a diagram illustrating a conventional device that meets detect-and-avoid (DAA) Minimum Operational Performance Standard (MOPS) of the International Civil Aviation Organization (ICAO). The flight vehicle meeting the DAA MOPS of the ICAO needs to be designed to be capable of viewing at angles of +−110 degrees in left and right directions and at angles of +−15 degrees in upward and downward directions as shown in FIG. 1A. Herein, the configuration of a conventional tracking system including an electro-optic (EO) sensor for meeting such a condition has been proposed as shown in FIG. 1A.

Herein, the conventional tracking system includes four EO sensors and a control unit. Herein, in an embodiment, Nvidia Drive PX2 may be used as the control unit. Also, the tracking system may connect the four EO sensors and the control unit via Gigabit Multimedia Serial Link (GMSL).

The EO sensors may be provided at ends 110 of wings that are positioned on a second axis 130. Herein, in the present invention, the second axis 130 may be an axis parallel to the wings of the flight vehicle. Also, according to an embodiment of the present invention, the second axis 130 may be an axis parallel to a reference axis of rotation when a flight vehicle, or the like performs pitch rotation.

Further, in the present invention, a first axis 120 may be an axis parallel to an axis that is perpendicular to the second axis 130. The first axis 120 may be an axis parallel to an axis that is in the movement direction of the flight vehicle. Herein, according to an embodiment of the present invention, the first axis 120 may be an axis parallel to a reference axis (roll axis) when a flight vehicle, or the like performs roll rotation.

Herein, the roll rotation of the flight vehicle may refer to rotation of the body of the flight vehicle with respect to the axis that is parallel to the front (traveling direction) of the flight vehicle and passes the flight vehicle's center of gravity. When the flight vehicle performs roll rotation, a reference axis that passes the flight vehicle's center of gravity is defined as a roll axis in the present invention.

Therefore, in the present invention, according to an embodiment, the first axis 120 may refer to the roll axis that passes the flight vehicle body's center of gravity, or may refer to axes that are parallel to the roll axis.

Herein, two of the EO sensors may be provided on each of the two wings of the flight vehicle, which are positioned on the second axis 130. More specifically, the sensors provided on one wing may be made up (110) of the sensor (EO sensor for forward view) facing the forward direction of the flight vehicle to obtain a forward image, and of the sensor (EO sensor for sideways view) facing the sideways direction of the flight vehicle to obtain a sideways image.

The image obtained from the conventional device is the same as the forward image with the field of view shown in FIG. 1B. Herein, the conventional device meets the EO standard but is vulnerable to the deformation of the wing. Also, due to vibration caused by the movement of the flight vehicle, it is impossible to perform stable tracking and avoidance functions.

Therefore, the present invention is intended to provide a device and an operation method, wherein the device is capable of receiving the image with the field of view shown in FIG. 1B while meeting the detect-and-avoid (DAA) MOPS, and of providing stable tracking and avoidance functions in spite of the movement of the flight vehicle.

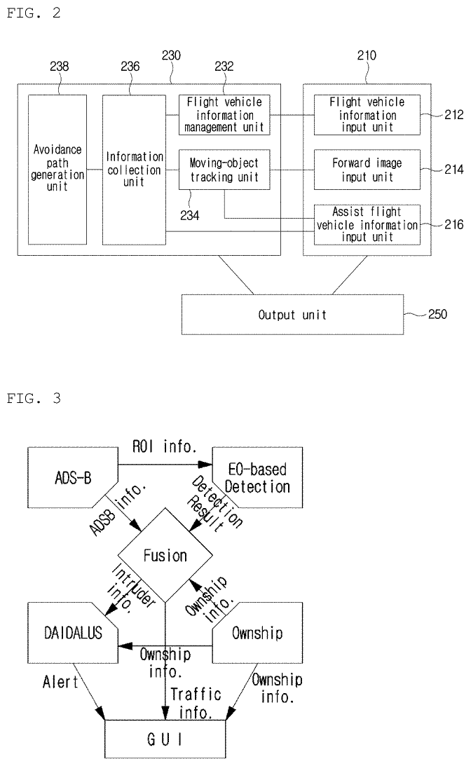

FIG. 2 is a diagram illustrating a configuration of an image-based detect-and-avoid (DAA) system for a flight vehicle according to an embodiment of the present invention.

The present invention relates to an image processing-based collision avoidance system for a flight vehicle, and to a flight vehicle including the system. Herein, the present invention may relate to a system for providing tracking and avoidance functions, which may be equipped in a flight vehicle, or the like. More specifically, the present invention proposes a new EO-based DAA system that meets the condition of the MOPS by providing an EO sensor on a vertical tail wing which does not change by the lift force.

Herein, the flight vehicle of the present invention may be a device capable of flying in the air, such as a crewed aircraft, an unmanned aircraft, a flight vehicle or the like. However, no limitation thereto is imposed, and any device that is moved and controlled in the air may be the flight vehicle of the present invention.

The system of the present invention may include an input unit 210, a control unit 230, and an output unit 250. According to an embodiment of the present invention, the input unit 210, the control unit 230, and the output unit 250 may be implemented in a single device. Alternatively, the input unit 210, the control unit 230, and the output unit 250 may be implemented as a separate device. As an example of the present invention, the input unit 210, and the control unit 230 may be implemented in the flight vehicle, and the output unit 230 may be implemented in a separate device using a display, or the like. Alternatively, the input unit 210 may be implemented in the flight vehicle, and the control unit 230 and the output unit 230 may be implemented as a separate device. When implemented into several devices, communication between the devices is supported for transmission and reception of information and signals.

More specifically, the input unit 210 includes a flight vehicle information input unit 212, a forward image input unit 214, and a assist flight vehicle information input unit 216.

The flight vehicle information input unit 212 may receive information on the flight vehicle equipped with the system. Therefore, pieces of information may be input such as preset information and changed information that are related to flight of the current flight vehicle.

The forward image input unit 214 may obtain a forward image of the direction in which the flight vehicle moves. Herein, the forward image input unit 214 may be a device, such as a camera, or the like, which receives an image. According to an embodiment of the present invention, the forward image input unit 214 may be an electro-optic (EO) sensor. Further, the forward image input unit 214 may be used, equipped with an IR camera/filter for night.

The assist flight vehicle information input unit 216 may receive information on a cooperative aircraft (flight vehicle) from an automatic dependent surveillance-broadcast (ADS-B) reception sensor. Also, the assist flight vehicle information input unit 216 may transmit the received information on the assist flight vehicle to a moving-object tracking unit 234.

As an embodiment of the present invention, an ADS-B receiver is also provided to identify the position of the aircraft transmitting an ADS-B signal. Therefore, it is possible to also identify position information of another aircraft without just relying only on an image.

The present invention relates to aircraft detection and avoidance, and may relate to a technique for safely avoiding both a cooperative aircraft (hereinafter, referred to as a assist flight vehicle) and a non-cooperative aircraft (hereinafter, referred to as a non-assist flight vehicle).

Herein, the assist flight vehicle is an aircraft that broadcasts its flight state and position through automatic dependent surveillance-broadcast (ADS-B) and that provides its information to other aircraft. However, ADS-B is not mandatory and most military or special purpose aircraft do not use ADS-B, so that it is necessary to actively detect/avoid the non-assist flight vehicle. The present invention may use the ADS-B reception sensor to detect the assist flight vehicle. The control unit 230 may include a flight vehicle information management unit 232, a moving-object tracking unit 234, an information collection unit 236, and an avoidance path generation unit 238.

The flight vehicle information management unit 232 may collect and manage the information on the flight vehicle, which is input from the flight vehicle information input unit 212. Also, the flight vehicle information management unit 232 may transmit the information on the flight vehicle to the information collection unit 236.

The moving-object tracking unit 234 may detect a moving object in the forward image and may continuously track the moving object.

Herein, in the present invention, the moving object may refer to a target tracked by the flight vehicle to which the system and the tracking method of the present invention are applied. Herein, the moving object may be objects that are present in the air, land, or ocean. Further, it does not matter that the moving object is currently moving or stopped. According to an embodiment of the present invention, the moving object may be a separate aircraft that is different from the flight vehicle equipped with the present invention; may be a bird, etc.; or may be an object, such as a ship, which can be seen in an image obtained by the present invention.

Also, according to an embodiment of the present invention, when the moving object is an aircraft, the aircraft may be the non-assist flight vehicle or the assist flight vehicle. Herein, when the moving object is the assist flight vehicle, the ADS-B reception sensor may be used for tracking. However, in the case of ADS-B, information updating is at 1 Hz, which is considerably slow, so that it is possible to increase the robustness in detecting the aircraft through the electro-optical (EO) sensor.

Herein, according to an embodiment of the present invention, the moving-object tracking unit 234 may detect an interest region containing the moving object from the forward image. Further, the moving-object tracking unit 234 may enlarge the interest region to identify the type of moving object.

Also, the moving-object tracking unit 234 may receive information on the interest region from the assist flight vehicle information input unit 216, and may detect the moving object on the basis of at least one among the information on the interest region and information on an analysis of the forward image.

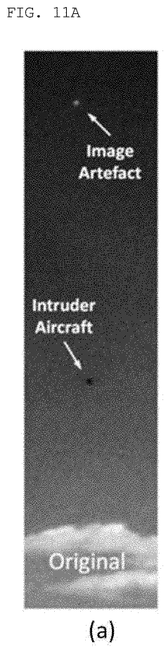

A more detailed method of detecting and tracking the moving object by the moving-object tracking unit 234 will be described with reference to FIG. 8.

The avoidance path generation unit 238 may generate an avoidance path on the basis of information for generating the avoidance path. Herein, the information for generating the avoidance path may include at least one among the information on the flight vehicle managed by the flight vehicle information management unit 232, information on the moving object detected by the moving-object tracking unit 234, and the information on the assist flight vehicle input to the assist flight vehicle information input unit 216.

The output unit 250 may output the information on the detected moving object, the avoidance path generated by the avoidance path generation unit 238, and the like. According to an embodiment of the present invention, the output unit 250 may be a display device for displaying an image processed by the control unit 230. Further, no limitation thereto is imposed, and the output unit 250 may be a device that represents a result of tracking and has a sound alarm function providing warning, or a device having a vibration alarm function.

FIG. 3 is a diagram illustrating data that is transmitted and received in an image-based detect-and-avoid (DAA) system for a flight vehicle according to an embodiment of the present invention.

Referring to FIG. 3, the assist flight vehicle information input unit 216 (ADS-B) may obtain information on the cooperative aircraft through ADS-B. Further, the information on the interest region may be transmitted to the moving-object tracking unit 234 (EO-based detection).

The device of the present invention may generate information (intruder information) on an intruder by combining a result of the detection by the moving-object tracking unit 234 (EO-based detection), the information (ADS-B information) on the assist flight vehicle from the assist flight vehicle information input unit 216 (ADS-B), and the information (ownship information) on the flight vehicle (ownship). The device of the present invention may generate an intruder detect-and-avoid (DAA) path using the information (intruder information) on the intruder and the information (ownship information) on the flight vehicle. Also, traffic information from the combined information may be received, and the intruder detect-and-avoid (DAA) path and the information on the flight vehicle may be used for implementation into the graphical user interface (GUI).

That is, the present invention may obtain the information on the cooperative aircraft through ADS-B, may supplement data of the cooperative aircraft through EO sensors, and may obtain the information on the intruder through active detection of the non-cooperative aircraft. Through this data fusion, the position/flight state of the intruder may be estimated to provide a warning of a risk of collision through Detect and Avoid Alerting Logic for Unmanned Systems (DAIDALUS) (an avoidance algorithm), and the avoidance path may be generated.

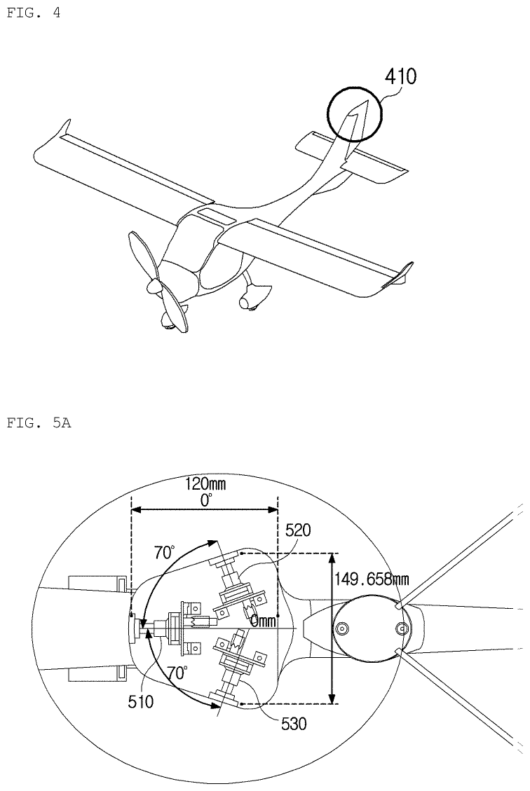

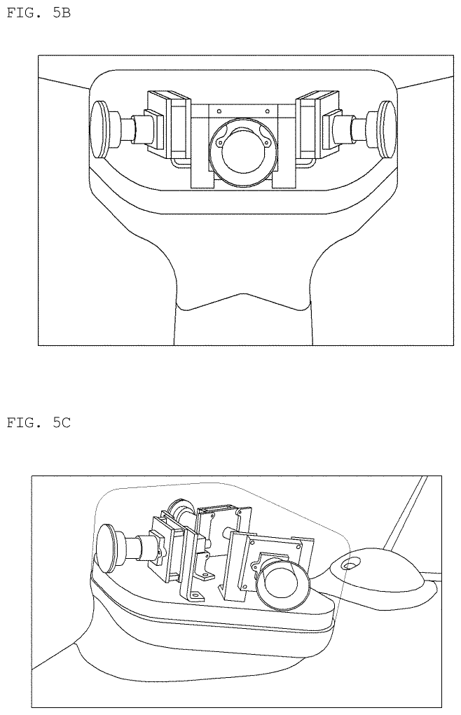

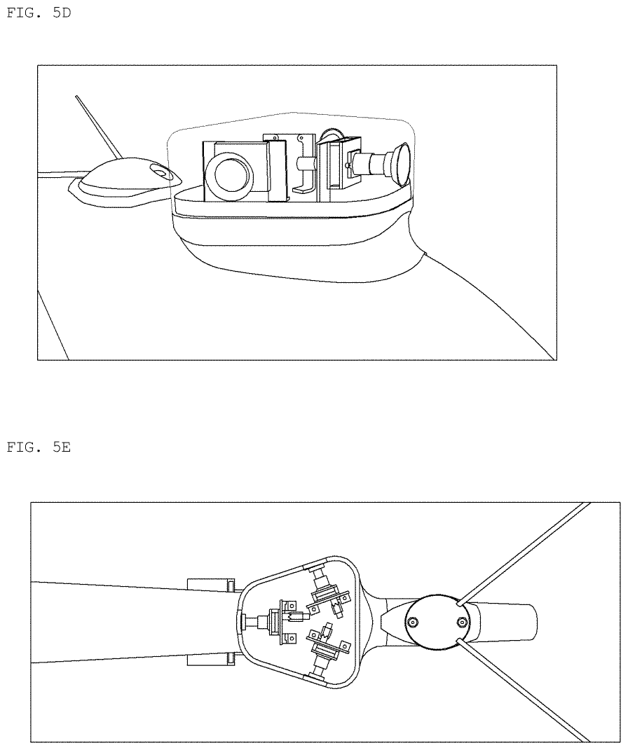

FIG. 4 and FIGS. 5A to 5E are diagrams illustrating a structure of a forward image input unit that receives a forward image in an image-based detect-and-avoid (DAA) system for a flight vehicle according to an embodiment of the present invention.

As shown in FIG. 4, the forward image input unit 214 receiving the forward image may be positioned on the first axis 120 of the flight vehicle. According to an embodiment of the present invention, the forward image input unit 214 receiving the forward image may be provided on the vertical tail wing (vertical tail) 410 that is positioned on the first axis 120 of the flight vehicle. More specifically, the forward image input unit 214 receiving the forward image may be positioned on an upper portion of the vertical tail wing (vertical tail) 410 that is positioned on the first axis 120 of the flight vehicle. Herein, since the vertical tail wing 410 is provided at a position where the vertical tail wing 410 does not change by the lift force, it is possible to stably receive the forward image.

Herein, the forward image input unit 214 may be composed of the EO sensors. According to an embodiment of the present invention, the forward image input unit 214 may be composed of three EO sensors as shown in FIG. 5A.

The diagrams of 5A to 5E show the configuration of the device, in which the forward image input unit 214 is implemented, viewed from the inside (FIG. 5A), the front (FIG. 5B), the left (FIG. 5C), the right (FIG. 5D), and the top (FIG. 5E) of the device. The images received from the sensor need to meet the condition of the MOPS. Therefore, according to the embodiment of the present invention for meeting the condition, the three EO sensors may be configured as shown in FIG. 5A.

A first sensor 510 may be positioned to be parallel to the first axis 120 of the flight vehicle. That is, according to an embodiment of the present invention, the first sensor 510 may be positioned on the roll axis that passes the flight vehicle's center of gravity, or may be positioned on the axes that are parallel to the roll axis. According to an embodiment of the present invention, the first sensor 510 may be positioned on the top of the vertical tail wing (vertical tail) that is positioned on the first axis 120.

A second sensor 520 may be positioned on the right, maintaining a particular angle with respect to the first sensor and the first axis 120 of the flight vehicle. Herein, as an embodiment of the present invention, the second sensor 520 may be positioned on the right at an angle of 70 degrees with respect to the first axis 120 of the flight vehicle. That is, the second sensor 520 may be positioned on the right at an angle of 70 degrees with respect to the first sensor 510. Herein, the first sensor 510 and the second sensor 520 may be present on the same plane.

A third sensor 530 may be positioned on the left, maintaining a particular angle with respect to the first sensor and the first axis 120 of the flight vehicle. Herein, as an embodiment of the present invention, the third sensor 530 may be positioned on the left at an angle of 70 degrees with respect to the first axis 120 of the flight vehicle. That is, the third sensor 530 may be positioned on the left at an angle of 70 degrees with respect to the first sensor 510. Herein, the first sensor 510 and the third sensor 530 may be present on the same plane.

According to an embodiment of the present invention, the first sensor 510, the second sensor 520, and the third sensor 530 may be present on the same plane. Also, herein, the vertical axis of the vertical tail wing (vertical tail) 410 may be perpendicular to the plane on which the first sensor 510, the second sensor 520, and the third sensor 530 are present.

According to an embodiment of the present invention, the horizontal length and the vertical length of the device, in which the forward image input unit is implemented, may be designed to preset values. As an embodiment of the present invention, implementation into the size as shown in FIG. 5A is possible. However, the values vary with the size of the flight vehicle, the size of the detect-and-avoid (DAA) system, the size of the used sensor, or the like, and is not limited to the embodiment.

According to an embodiment of the present invention, the ADS-B reception sensor may be added, but unlike the forward image input unit, the position at which the ADS-B reception sensor is provided is not limited to the top of the vertical tail wing 410 that is positioned on the first axis 120 of the flight vehicle.

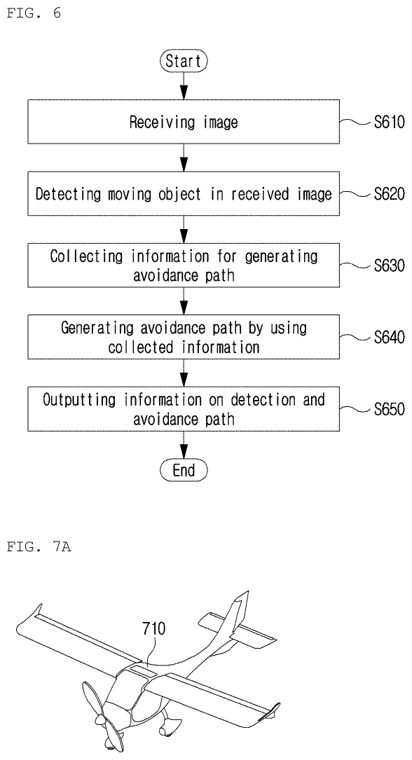

FIG. 6 is a flowchart illustrating a detect-and-avoid (DAA) method of an image-based detect-and-avoid (DAA) system for a flight vehicle according to an embodiment of the present invention.

First, the forward image input unit 214 may receive the forward image of the direction in which the flight vehicle moves, at step S610. The moving-object tracking unit 234 may detect the moving object in the forward image for tracking, at step S620. The information collection unit 236 may manage and collect information for generating the avoidance path, which includes the information on the detected moving object, at step S630. The avoidance path generation unit 238 may generate the avoidance path on the basis of the information for generating the avoidance path, at step S640. The output unit 250 may output the information on the detected moving object and the avoidance path, at step S650.

Hereinafter, embodiments for a method of tracking an obstacle by the image-based detect-and-avoid (DAA) system for the flight vehicle of the present invention will be described with reference to the accompanying drawings.

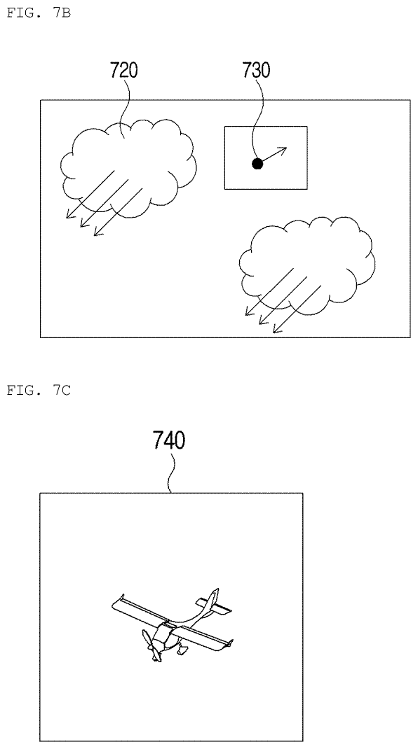

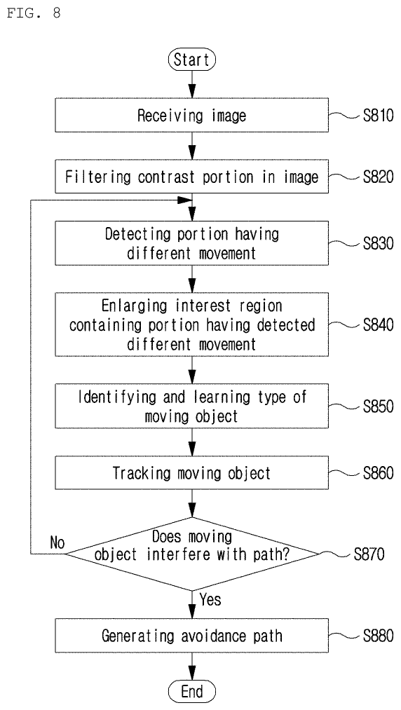

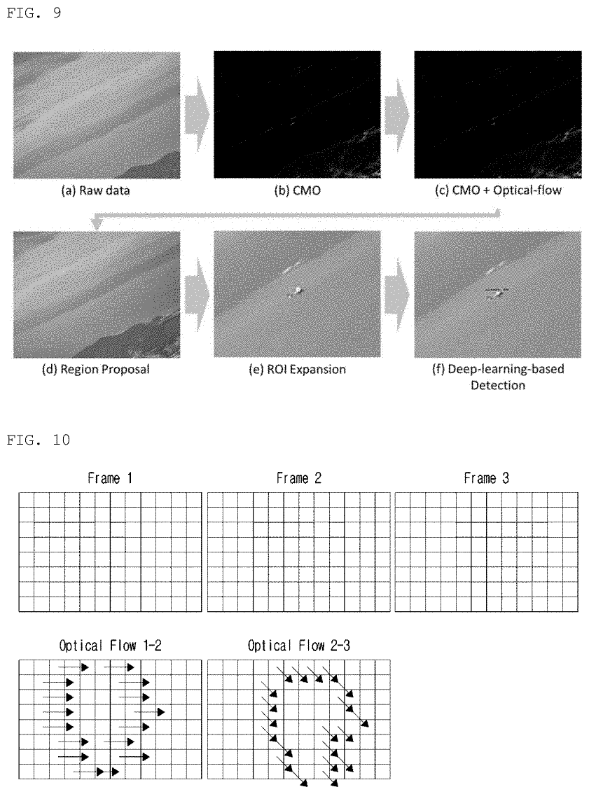

FIGS. 7A to 7C are diagrams illustrating operation of a detect-and-avoid (DAA) device of a flight vehicle according to an embodiment of the present invention.

The present invention relates to an image-based detect-and-avoid (DAA) method and device for the flight vehicle. In the present invention, the flight vehicle refers to a device capable of flying indicated by the reference numeral 710 of FIG. 7A, and may be an UAV or crewed aircraft.

In the related art, there is a problem that when the flight vehicle 710 detects an obstacle through image processing, a flight vehicle in remote distance appears in the same size as the dot 730 in FIG. 7B and it is difficult to distinguish whether the flight vehicle in remote distance is an intruder. Also, since the flight vehicle 710 keeps moving, change in the background 730 of the image needs to be considered.

Herein, an object 730 that the flight vehicle 710 tracks may be defined as a moving object in the present invention.

Accordingly, in the present invention, in order to solve the problem in the related art, an object which is suspected of being a moving object in the image is first detected. Herein, a method of identifying the movements of the objects in the obtained image as shown in FIG. 7B may be used. As shown in FIG. 7B, the object that executes the movement different from that of the background object 710 may be recognized as the moving object 730 for tracking.

Further, when the object executing the different movement is suspected of being the moving object 730, it is determined whether the object substantially interferes with the path of the flight vehicle. According to the present invention, a method of distinguishing an aircraft by enlarging the interest region 740 containing the moving object 730 may be provided as shown in FIG. 7C.

FIG. 8 is a flowchart illustrating operation of a detect-and-avoid (DAA) device of a flight vehicle according to an embodiment of the present invention. FIG. 9 is a diagram illustrating an image in order that is processed by a detect-and-avoid (DAA) method according to an embodiment of the present invention.

First, in order to perform the image-based detect-and-avoid (DAA) method for the flight vehicle, the moving-object tracking unit 234 may receive an image from the forward image input unit 214 provided on the flight vehicle, at step S810. Herein, according to an embodiment of the present invention, the original image that the input unit 214 receives is shown in FIG. 9.

The moving-object tracking unit 234 may first perform filtering (positive or negative contrast) on a contrast portion in the original image to detect the interest region containing the moving object from the received image, at step S820.

In order to perform image processing, an algorithm is selected according to the purpose of use. As in the present invention, in order to detect an aircraft (or something) in remote distance (2 km or more), it is necessary to detect an object that looks like a dot of which the shape or color is unclear, and thus an algorithm having a function for the detection needs to be performed. Herein, according to an embodiment of the present invention, a combination of the close-minus-open (CMO) operation and the optical-flow operation may be used.

First, the close-minus-open (CMO) operation related to filtering may be applied to the original image. Herein, the image obtained by applying the CMO operation to the input image is shown as the image (b) in FIG. 9.

In the case of filtering the received image according to an embodiment of the present invention, the received image may be binarized to generate a binarization image, and then a first image and a second image may be generated with respect to the binarization image. Next, a difference image between the first image and the second image may be obtained.

Herein, according to an embodiment of the present invention, the first image and the second image may be images obtained by applying different morphology operations. More specifically, the first image may be an image obtained by performing a closing operation in which a dilation operation is performed on the binarization image and then an erosion operation is performed. Also, the second image may be an image obtained by performing an opening operation in which an erosion operation is performed on the binarization image and then a dilation operation is performed.

Herein, the close-minus-open (CMO) operation may be the most appropriate method of extracting all contrast portions through morphological transformation (morphological operations). Therefore, the close-minus-open (CMO) operation is an image processing method applied to a region in which the contrast portion is to be found regardless of shape.

However, the biggest problem with using the CMO operation for the tracking and avoidance method for the flight vehicle is that all contrast portions are the results of filtering and unnecessarily large portions having color contrast in the image are the results thereof. Also, there is a limit that due to the cloud/terrain of the background in the image, the result of image processing is so unclear that the result is unable to be used for detecting the aircraft. In other words, the CMO operation may be used for detecting the aircraft when only the aircraft is present in the solid-color sky. Therefore, the present invention proposes a method in which the received image is subjected to the CMO operation and then the optical-flow operation is applied to consider the movement of the object.

The moving-object tracking unit 234 may detect the moving object on the basis of the movement with respect to the image obtained by performing filtering (positive or negative contrast) on the contrast portion in the original image, at step S830.

Herein, considering that the moving object which is moving or stopped and the background such as clouds and the sea have movements according to the movement of the flight vehicle, among one or more objects contained in the filtered image, the object of which at least one among the movement direction and the movement speed is different from that of the other objects may be determined as the moving object according to an embodiment of the present invention. That is, among the one or more objects contained in the filtering image, the objects other than the moving object may be the background screen such as the cloud, the ocean, or the like, which does not interfere with the movement of the flight vehicle.

Herein, there is one or more moving objects. In the case where one or more moving objects is present, considering the movement of the flight vehicle, among the one or more objects contained in the filtering image, the objects of which the movement directions or the movement speeds or both are different from those of the other objects may be determined as the moving objects.

Herein, according to an embodiment of the present invention, regarding the movement in the image on which filtering with the CMO operation is performed, the moving object may be detected by applying the optical-flow technique. The optical-flow operation is applied to the result of applying the CMO operation and it is shown as the image (c) in FIG. 9.

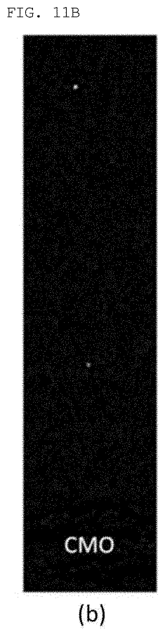

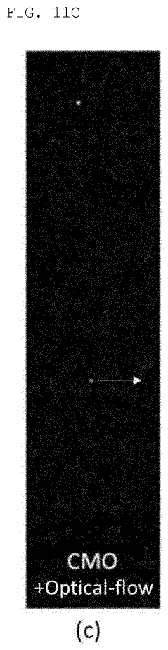

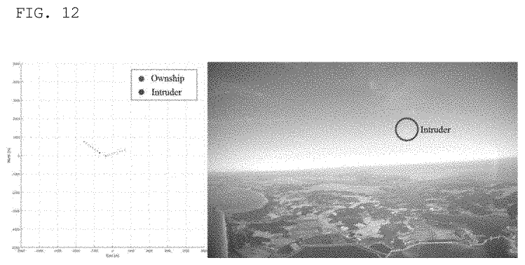

FIG. 10 is a diagram illustrating a general optical-flow operation. FIGS. 11A to 11C are diagrams illustrating a result of simultaneously applying a close-minus-open (CMO) operation and an optical-flow operation as in the present invention.

As shown in FIG. 10, the optical-flow operation is a technique where the preceding frame and the subsequent frame are compared to analyze which direction the object has moved. That is, referring to FIG. 10, it is found that the direction in which the block blocks have moved as shown in Frame 1 to Frame 2 is indicated by arrows in Optical Flow 1-2, and that the direction in which the black blocks have moved as shown in Frame2 to Frame3 is indicated by arrows in Optical Flow 2-3. Referring to FIGS. 11A to 11C, after the color-contrast portion is filtered through the above-described close-minus-open (CMO) operation as shown in FIG. 11B, when the optical-flow technique is applied, a thing (suspected of being an aircraft) such as the arrow shown in FIG. 11C, which moves in the entire image may be found.

The advantage of this optical-flow technique is that it is possible to use the fact that since an aircraft keeps moving, the movement of the entire background and the movement (maneuver) of the flying intruder differ. In other words, in the case of applying the CMO operation and the optical-flow operation together, when the ownship aircraft (ownship) detects the outside using an image while flying, it is possible to detect the intruder even though there is no information on the intruder because the intruder has a movement different from that of the background from the point in time when the intruder in remote distance looks like a dot.

Afterward, the moving-object tracking unit 234 may enlarge the interest region, at step S840. That is, the moving-object tracking unit 234 may enlarge the portion where the detected movement is different from that of the remaining portion.

Further, the moving-object tracking unit 234 may identify the type of moving object, at step S850. The moving-object tracking unit 234 may enlarge the interest region, may identify the type of moving object by performing deep learning on the enlarged interest region, and may learn the identified result.

Herein, according to an embodiment of the present invention, deep learning may be performed as a method of identifying the type of moving object and learning the identified result. However, the method of learning is not limited thereto, and a method of performing machine learning may correspond thereto.

As described above, the moving-object tracking unit 234 performs a deep learning-based aircraft detection algorithm, so that even if an unexpected result of filtering is obtained with respect to various environments, it is possible to distinguish the aircraft on the basis of probability. Further, by adding a determination class, it is possible to distinguish/determine various moving objects such as a bird, or a replica flight vehicle.

Also, according to an embodiment of the present invention, in order to identify the type of moving object, a technique may be used in which a CAD model which is a 3D model of an aircraft is compared with the image to determine the aircraft. In this case, there is an advantage that it is possible to estimate even positioning values (roll/pitch/yaw) of the aircraft. However, unless the models of all aircraft are provided, there is a limit that accurate estimation is impossible.

According to the present invention, since it is possible to detect the dangerous things during the flight by applying the method of simultaneously applying the CMO operation and the optical-flow operation, it is possible to detect the danger without deep learning. However, in the present invention, the deep learning-based determination is performed at the end, so that even in an unexpected situation, it is possible to stably detect the moving object by identifying and learning the aircraft.

Afterward, the moving-object tracking unit 234 may continuously track whether the moving object is in the path of the flight vehicle, at step S860. Herein, when the moving object is present in the path of the flight vehicle, the moving-object tracking unit 234 transmits a moving object avoidance signal to the avoidance path generation unit 238.

Therefore, the moving-object tracking unit 234 may track the movement in the interest region containing the moving object, and may identify whether the moving object is in the travel path of the flight vehicle, at step S870.

When the moving object does not interfere with the travel path, the portion having different movement is continuously detected and tracked.

Conversely, when the moving object interferes with the travel path, the avoidance path generation unit 238 generates a path for avoiding the moving object, at step S880.

According to an embodiment of the present invention, in the case where the flight vehicle avoids the moving object, the avoidance path generation unit 238 may automatically generate the avoidance path for the detected moving object on the basis of at least one piece of information among the position, movement direction, and movement speed of the moving object.

Also, according to an embodiment of the present invention, in the case where the moving object is in the travel path of the flight vehicle, an alarm about a risk of collision may be sounded.

Also, according to an embodiment of the present invention, the avoidance algorithm, specifically, Detect and Avoid Alerting Logic for Unmanned Systems (DAIDALUS), may be used.

As in the present invention, when detecting an aircraft in remote distance, it is difficult to distinguish the shape of aircraft. Thus, finding a thing having movement first is important (Human-like) for safe flight. Also, in the present invention, the movement in the image is detected, so that it is useful for detection as well as continuous tracking. Also, it is possible to identify aircrafts, birds, and other types of flying through object distinguish using deep learning based on the shape.

FIG. 12 is a diagram illustrating an output image screen according to an embodiment of the present invention.

As an embodiment of the present invention, the tracking and avoidance system may include a Linux-based computer for image processing. Also, in addition to image processing, GPS and flight data (positioning values) may be processed in real time and logged.

Herein, the left graph of FIG. 12 shows GPS information, and the appearance of the tracked intruder when being in the corresponding position is output to the screen with the movement direction.

The various embodiments of the present disclosure are not intended to list all possible combinations, but to illustrate representative aspects of the present disclosure. The matters described in the various embodiments may be applied independently or in a combination of two or more.

Also, the various embodiments of the present disclosure may be implemented by hardware, firmware, software, or a combination thereof. With hardware implementation, the embodiment may be implemented by using at least one selected from a group of application specific integrated circuits (ASICs), digital signal processors (DSPs), digital signal processing devices (DSPDs), programmable logic devices (PLDs), field programmable gate arrays (FPGAs), general-purpose processors, controllers, micro controllers, microprocessors, etc.

Various substitutions, modifications, and changes from the spirit of the present invention defined in the following claims by those skilled in the art are also included in the scope of the present invention, so that the present invention described above is not limited to the embodiments and the accompanying drawings.

What is claimed is:

1. An image processing-based collision avoidance method for a flight vehicle, the method comprising:
receiving an image from an input unit provided on the flight vehicle;
detecting an interest region containing a moving object from the received image;
enlarging the interest region to identify a type of the moving object; and
avoiding the moving object when the moving object is in a path of the flight vehicle,
wherein when the moving object is detected, the received image is filtered and the moving object is detected on the basis of movement in the filtered image.

2. The method of claim 1, wherein when the received image is filtered,
the received image is binarized to generate a binarization image, and then a first image and a second image are generated with respect to the binarization image, and
a difference image between the first image and the second image is obtained.

3. The method of claim 2, wherein the first image and the second image are images obtained by applying different morphology operations.

4. The method of claim 1, wherein among one or more objects contained in the filtered image, an object of which at least one among a movement direction and a movement speed is different from that of the other objects is determined as the moving object.

5. The method of claim 1, wherein the movement in the filtered image is determined using an optical-flow technique.

6. The method of claim 1, wherein movement in the interest region containing the moving object is tracked, and whether the moving object is in the path of the flight vehicle is identified.

7. The method of claim 1, wherein the interest region is enlarged and deep learning is performed so that the type of the moving object is identified.

8. The method of claim 1, when avoiding the moving object, the flight vehicle automatically generates an avoidance path for the detected moving object on the basis of at least one piece of information among a position, a movement direction, and a movement speed of the moving object.

9. The method of claim 1, wherein when the moving object is in the path of the flight vehicle, a warning of a risk of collision is transmitted.

10. The method of claim 1, wherein the input unit includes an electro-optic (EO) sensor.

11. An image-based collision avoidance system for a flight vehicle, the system comprising:
a forward image input unit obtaining an forward image of a direction in which the flight vehicle moves;
a moving-object tracking unit detecting and tracking a moving object in the forward image;
an avoidance path generation unit generating an avoidance path by using information on the detected moving object; and
an output unit outputting the information on the detected moving object and the avoidance path,
wherein the forward image input unit is provided on a vertical tail wing that is positioned on a first axis of the flight vehicle.

12. The system of claim 11, wherein the forward image input unit is composed of three electro-optic (EO) sensors.

13. The system of claim 12, wherein the forward image input unit is composed of,
a first sensor that is positioned to be parallel to the first axis of the flight vehicle;
a second sensor that is positioned on a right at an angle of 70 degrees with respect to the first sensor; and
a third sensor that is positioned on a left at an angle of 70 degrees with respect to the first sensor.

14. The system of claim 11, further comprising:
an assist flight vehicle information input unit,
wherein the assist flight vehicle information input unit transmits information on an assist flight vehicle, which is received from an automatic dependent surveillance-broadcast (ADS-B) reception sensor, to the moving-object tracking unit.

15. The system of claim 14, further comprising:
an information collection unit,
wherein the information collection unit collects information on the flight vehicle and the information on the assist flight vehicle, which are received, and provides the collected information to the avoidance path generation unit that generates information for generating the avoidance path.

16. The system of claim 14, wherein the moving-object tracking unit detects an interest region containing the moving object from the forward image and enlarges the interest region to identify a type of the moving object.

17. The system of claim 16, wherein the moving-object tracking unit receives information on the interest region from the assist flight vehicle information input unit, and detects the moving object on the basis of at least one piece of information among the information on the interest region and information on an analysis of the forward image.

18. The system of claim 16, wherein when the moving-object tracking unit detects the moving object,
the forward image is filtered, and
the moving object is detected on the basis of movement in the filtered image.

19. The system of claim 16, wherein the moving-object tracking unit enlarges the interest region and performs deep learning on the interest region to identify the type of the moving object.

20. The system of claim 16, wherein movement in the filtering image is determined using an optical-flow technique.
